(19) United States
(12) Patent Application Publication
(10) Pub. No.: US 2014/0016187 A1
(43) Pub. Date: Jan. 16, 2014

(54) OPTICAL ELEMENT AND IMAGING APPARATUS INCLUDING THE SAME

(71) Applicant: PANASONIC CORPORATION, Osaka (JP)

(72) Inventors: Jun MURATA, Osaka (JP); Takamasa TAMURA, Osaka (JP)

(73) Assignee: PANASONIC CORPORATION, Osaka (JP)

(21) Appl. No.: 14/029,137

(22) Filed: Sep. 17, 2013

Related U.S. Application Data
(63) Continuation of application No. PCT/JP2013/000623, filed on Feb. 5, 2013.

(30) Foreign Application Priority Data
Feb. 6, 2012 (JP) 2012-022676

(51) Int. Cl. G02B 1/11

(52) U.S. Cl. CPC G02B 1/11
USPC 359/350; 359/613

(57) ABSTRACT

A lens includes a first optical surface, and a first cut end surface outside the first optical surface. The first optical surface has a SWS configured to reduce reflection of light. The first cut end surface has a SWS configured to reduce reflection of light and a reflection surface configured to reflect light having a predetermined wavelength.

### CROSS-REFERENCE TO RELATED APPLICATIONS

This is a continuation of International Application No. PCT/JP2013/000623 filed on Feb. 5, 2013, which claims priority to Japanese Patent Application No. 2012-022676 filed on Feb. 6, 2012. The entire disclosures of these applications are incorporated by reference herein.

### BACKGROUND

A technique disclosed herein relates to optical elements including surfaces having antireflection structures configured to reduce reflection of incident light.

In recent years, various optical elements including surfaces having antireflection structures for reducing reflection of light have been proposed.

A technique has been proposed in which fine structural units (e.g., fine structures made of linear recessed portions or linear raised portions, or fine structures made of conical or columnar recessed portions or raised portions) as antireflection structures are formed on a surface of an optical member with a pitch smaller than or equal to the wavelength of incident light.

For example, in Japanese Patent Publication No. 2008-276059, an antireflection structure is formed not only on an optical functional surface of a lens but also on a non-optical functional surface of a cut end portion, or the like, and an opaque film is further formed on the antireflection structure of the non-optical functional surface. In this way, reflection at the entire surface of the lens is reduced.

### SUMMARY

When a lens is attached to a lens frame or a barrel, a tilt of the lens may be adjusted. The tilt of the lens is adjusted by irradiating the lens with a laser beam, and observing reflected light of the laser beam.

However, when the reflectance of the entire lens is low, the reflected light cannot be observed, and the tilt of the lens cannot be adjusted. Normally, in many cases, a cut end surface is irradiated with a laser beam to adjust the tilt of the lens. However, when the antireflection structure is provided also on the cut end surface as in Japanese Patent Publication No. 2008-276059, it becomes more difficult to adjust the tilt of the lens. That is, it is difficult to achieve both reduction of the reflection of portions other than optical functional surface and adjustment of the tile of the lens.

A technique disclosed herein was devised in view of the foregoing, and is directed to achieve both the reduction of the reflection of portions other than optical functional surface and the adjustment of the tile of the lens.

An optical element disclosed herein includes: an optical functional surface; and a peripheral surface outside the optical functional surface, wherein the optical functional surface has an antireflection structure configured to reduce reflection of light, and the peripheral surface has an antireflection structure configured to reduce reflection of light and a reflection surface configured to reflect light having a predetermined wavelength.

An imaging apparatus disclosed herein includes the optical element.

According to the optical element, it is possible to achieve both the reduction of the reflection of portions other than optical functional surface and the adjustment of the tile of the lens.

According to the imaging apparatus, it is possible to achieve both the reduction of the reflection of portions other than optical functional surface and the adjustment of the tile of the lens.

### BRIEF DESCRIPTION OF THE DRAWINGS

FIGS. 1A and 1B are views illustrating a lens, where FIG. 1A is a sectional view, and FIG. 1B is a plan view.

FIG. 2 is an enlarged sectional view illustrating a raised portion.

FIG. 3 is a layout illustrating the lens and an adjustment device in performing a tilt adjustment.

FIG. 4 is a view illustrating a screen of a monitor of the adjustment device.

FIGS. 5A-5F are views illustrating steps for forming a molding die used for injection molding.

FIG. 6 is a view schematically illustrating a camera.

FIGS. 7A and 7B are views illustrating a lens according to a first variation, where FIG. 7A is a sectional view, and FIG. 7B is a plan view.

FIG. 8 is a plan view illustrating a lens according to a second variation.

FIG. 9 is a plan view illustrating a lens according to a third variation.

FIG. 10 is an enlarged sectional view illustrating an optical element according to another embodiment.

FIG. 11 is an enlarged sectional view illustrating an optical element according to still another embodiment.

FIGS. 12A-12H are perspective views illustrating raised portions according to variations of other embodiments.

### DETAILED DESCRIPTION

Embodiments are described in detail below with reference to the attached drawings. However, unnecessarily detailed description may be omitted. For example, detailed description of well known techniques or description of the substantially same elements may be omitted. Such omission is intended to prevent the following description from being unnecessarily redundant and to help those skilled in the art easily understand it.

Inventors provide the following description and the attached drawings to enable those skilled in the art to fully understand the present disclosure. Thus, the description and the drawings are not intended to limit the scope of the subject matter defined in the claims.

An example embodiment will be described in detail below with reference to the drawings.

[1. Optical Element]

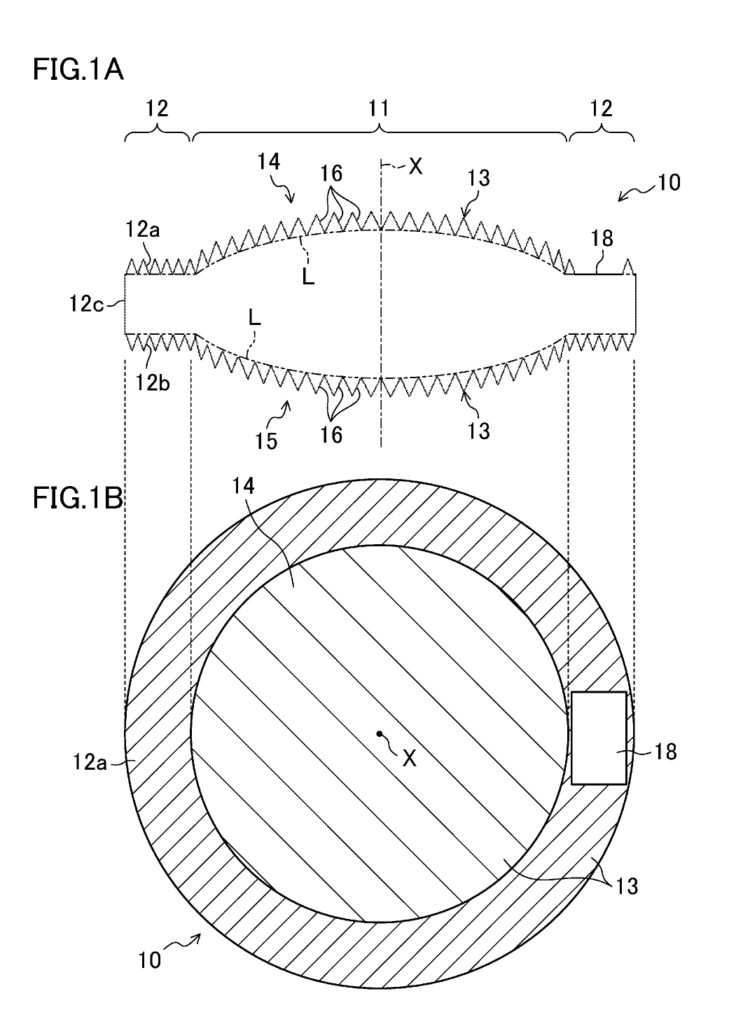

FIGS. 1A and 1B show a lens 10, where FIG. 1A is a sectional view, and FIG. 1B is a plan view. Note that in FIG. 1B, raised portions 16 are omitted.

The lens 10 includes an optical portion 11 including an optical axis X and a cut end portion 12 provided at an outer periphery of the optical portion 11. The optical portion 11 and the cut end portion 12 constitute an element body. The lens 10 is a biconvex lens. The lens 10 is a resin molded product produced by injection molding. The lens 10 is an example of an optical element.

The optical portion 11 includes a first optical surface 14 and a second optical surface 15. The first and second optical surfaces 14 and 15 are optical functional surfaces (also referred to as optical effective surfaces).

The cut end portion 12 includes a first cut end surface 12a on the same side as the first optical surface 14, a second cut end surface 12b on the same side as the second optical surface 15, and an outer circumferential surface 12c. A plane including the first cut end surface 12a intersects the optical axis X, specifically, is orthogonal to the optical axis X.

Likewise, a plane including the second cut end surface 12b intersects the optical axis X, specifically, is orthogonal to the optical axis X. Note that it is not necessary for the first cut end surface 12a and the second cut end surface 12b to be orthogonal to the optical axis X. The first cut end surface 12a and the second cut end surface 12b are examples of a peripheral surface.

The first optical surface 14, the second optical surface 15, the first cut end surface 12a, and the second cut end surface 12b each have a sub-wavelength structure (SWS) 13. The SWS 13 is an example of an antireflection structure. The SWS 13 includes a plurality of fine structural units arranged with a pitch smaller than or equal to a predetermined pitch (period), and can reduce reflection of light having a wavelength longer than or equal to the predetermined pitch. Structural units of the SWS 13 of the present embodiment are raised portions 16. The raised portions 16 each have a conical shape. The configurations of the SWSs 13 of the first optical surface 14 and the second optical surface 15 are the same as the configurations of the SWSs 13 of the first cut end surface 12a and the second cut end surface 12b.

The plurality of raised portions 16 are arranged in the SWS 13, so that a plurality of recessed portions are each formed by being surrounded by the raised portions 16. A virtual surface formed by connecting bottoms (the lowest portions) of the recessed portions is referred to as a base surface L. The base surface L is formed to have a shape necessary for obtaining optical properties required for the lens 10. The base surface L is a curved surface. For example, the base surface L may be a spheric surface, an aspheric surface, or a free-form surface. Note that the base surface L may be a flat surface.

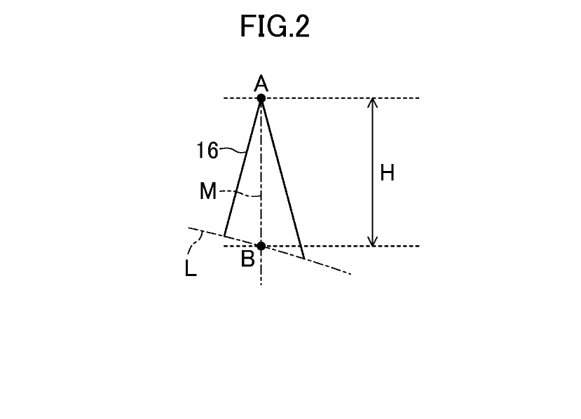

Here, the pitch of the raised portions 16 is a distance between vertices of adjacent ones of the raised portions 16 in a direction parallel to a plane orthogonal to the optical axis X. Moreover, the height of each raised portion 16 in the optical axis direction is a distance from the vertex of the raised portion 16 to the base surface L in the optical axis direction. FIG. 2 is an enlarged sectional view illustrating the raised portion 16. As illustrated in FIG. 2, the vertex of the raised portion 16 is denoted by A, a line segment extending from the vertex A in the optical axis direction is denoted by M, and an intersection of the line segment M and the base surface L is an intersection B. The height H of each raised portion 16 in the optical axis direction is defined by a distance from the vertex A to the intersection B. Note that the tip of the raised portion 16 actually formed may have a small curvature. In this case, the topmost portion of the raised portion 16 is the vertex A. The “height of the raised portion(s),” unless otherwise specified, hereinafter means the height in the optical axis direction.

The SWS 13 can reduce reflection of light having at least a wavelength longer than or equal to the pitch of the raised portions 16. When the lens 10 is used in an imaging optical system, light whose reflection is to be reduced is visible light. In this case, since a target wavelength is 400 nm-700 nm, the pitch of the raised portions 16 is preferably less than or equal to 400 nm

Moreover, in order to enhance the effect of antireflection, the height of the raised portions 16 is preferably 0.4 or more times as large as the target wavelength. When the target wavelength is that of visible light, the height of the raised portions 16 is preferably greater than or equal to 280 nm

Moreover, in order to prevent light from being diffracted at the SWS 13, the pitch of the raised portions 16 is preferably less than or equal to a solution obtained by dividing the target wavelength by the refractive index of the lens 10. When the target wavelength is that of visible light, and the refractive index of the lens 10 is 1.5, the pitch of the raised portions 16 is less than or equal to 266 nm

Note that the optical functional surface of the lens 10 preferably has a relatively low reflectance and a relatively high transmittance. For example, when the pitch of the raised portions 16 is 230 nm, and the height of the raised portions 16 is 350 nm, the reflectance in the entire range of visible light can be lower than or equal to 0.1-0.2%, so that it is possible to obtain a satisfactory effect of antireflection.

Here, the first cut end surface 12a includes a reflection surface 18 configured to reflect infrared light. The reflection surface 18 is not provided with the raised portions 16, but is flat. The reflection surface 18 is formed in part of the first cut end surface 12a. Specifically, the reflection surface 18 is rectangular. The reflection surface 18 is a surface used in adjusting a tilt of the lens 10 which will be described later. Thus, the reflectance of the reflection surface 18 with respect to infrared light (wavelength 700 nm-1000 nm) may be at a level at which the tilt can be adjusted, and may be, for example, about 1% or higher.

[2. Adjustment of Tilt of Lens]

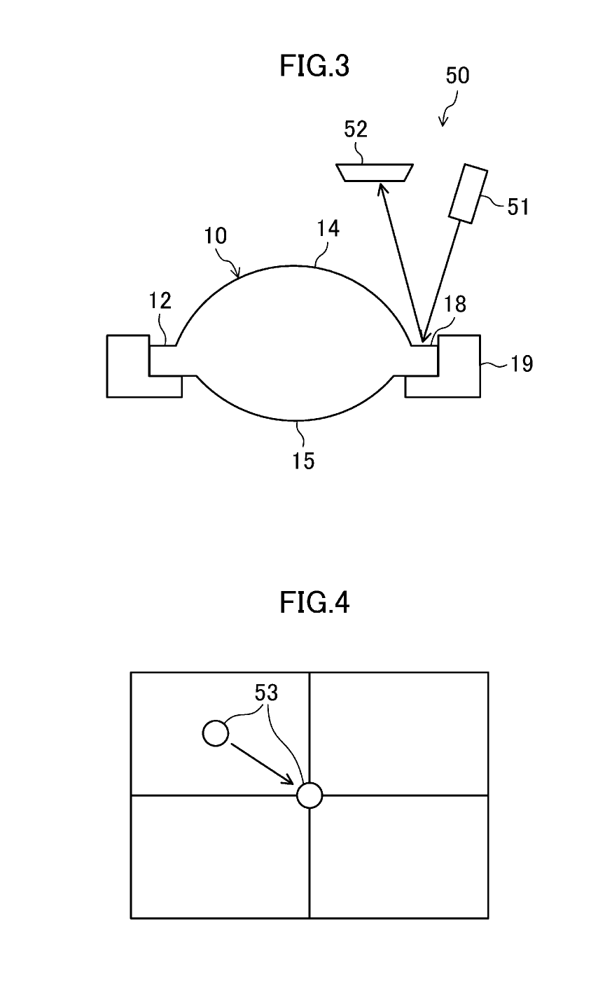

When the lens 10 is attached to a lens frame, or the like, a tilt of the optical axis X is adjusted. FIG. 3 shows a layout of the lens 10 and an adjustment device 50 in adjusting the tilt. FIG. 4 shows a monitored image of the adjustment device 50.

The lens 10 is attached to a lens frame 19. At that time, the lens 10 is fixed to the lens frame 19 via an adhesive such as UV curing resin.

The adjustment device 50 includes a laser light source 51 and a light receiving portion 52. The laser light source 51 outputs a laser beam (e.g., an infrared laser beam having a wavelength of 850 nm). The light receiving portion 52 receives the laser beam reflected from the lens 10.

In adjusting the tilt, the lens 10 is first attached to the lens frame 19. At this point, the adhesive is not cured. Next, the reflection surface 18 of the lens 10 is irradiated with a laser beam from the laser light source 51. The light receiving portion 52 receives light reflected from the reflection surface 18. The adjustment device 50 displays a spot image 53 of the reflected and received light on a monitor as shown in FIG. 4.

Subsequently, the tilt and the position of the lens 10 relative to the lens frame 19 are adjusted so that the spot image 53 is displayed on a predetermined position on a screen of the monitor (the center of the screen of the monitor in the example of FIG. 4). After completion of the adjustment, the adhesive is irradiated with UV light to fix the lens 10 to the lens frame 19.

[3. Production of Lens]

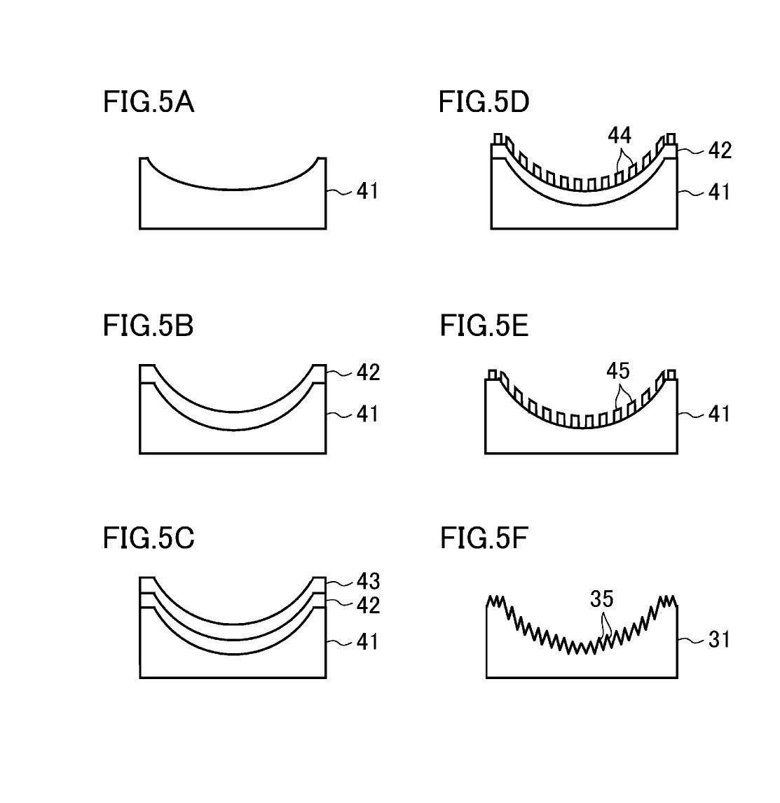

The lens 10 is produced by injection molding. FIGS. 5A-5F are views illustrating steps for forming a molding die used in the injection molding. The molding die includes a molding die for molding the first optical surface 14, and a molding die for molding the second optical surface 15. Here, steps for forming one of the molding dies will be described, but the other of the molding dies can be formed in similar steps.

First, a molding die base material 41 is prepared. Then, as illustrated in FIG. 5A, an inverted shape of the lens 10 is formed in the molding die base material 41 by mechanical processing. The inverted shape of the lens 10 at this point means the inverted shape of the lens 10 with the raised portions 16 being omitted from the optical surface and the cut end surface, and corresponds to the base surface L of the lens 10. The molding die base material 41 may be a material which has a high strength and in which a fine pattern can be easily formed by etching. For example, as the molding die base material 41, SiO₂ (quartz), Si (silicon), GC (glassy carbon), SiC (silicon carbide), WC (cemented), or the like may be used.

Next, as illustrated in FIG. 5B, a metal mask 42 is formed on a surface of the molding die base material 41. The metal mask 42 may be formed by sputtering or vapor deposition. As a material of the metal mask 42, Cr, Ta, WSi, Ni, W, or the like may be used.

Subsequently, as illustrated in FIG. 5C, a resist mask 43 is formed on the metal mask 42. The resist mask 43 may be formed by spin coating, spray coating, or the like.

After that, as illustrated in FIG. 5D, a resist dot pattern 44 corresponding to the SWS 13 is formed from the resist mask 43. The resist dot pattern 44 may be formed by electron beam lithography, interference exposure (hologram exposure), or the like. The resist dot pattern 44 is formed not only on a portion corresponding to the optical surface, but also on a portion corresponding to the cut end surface.

Next, as illustrated in FIG. 5E, the resist dot pattern 44 is transferred to the metal mask 42 by dry etching. Thus, a metal mask dot pattern 45 is formed. Alternatively, the metal mask dot pattern 45 may be formed by wet etching. In the same manner as the resist dot pattern 44, the metal mask dot pattern 45 is formed not only a portion corresponding to the optical surface but also a portion corresponding to the cut end surface.

Subsequently, as illustrated in FIG. 5F, the metal mask dot pattern 45 is transferred to the molding die base material 41 by dry etching. Thus, recessed portions 35 having an inverted shape of the raised portions 16 are formed on the surface of the molding die base material 41. In the same manner as the metal mask dot pattern 45, the recessed portions 35 are formed not only on a portion corresponding to the optical surface but also on a portion corresponding to the cut end surface. Note that the recessed portions 35 are formed not on the entire portion corresponding to the cut end surface, that is, are not formed on a portion corresponding to the reflection surface 18. The portion corresponding to the reflection surface 18 is formed by a flat plane.

Thus, a molding die 31 is formed. The other molding die is also formed in a similar manner. Note that in the other molding die, the recessed portions 35 are formed on the entire portion corresponding to the cut end surface.

[4. Camera]

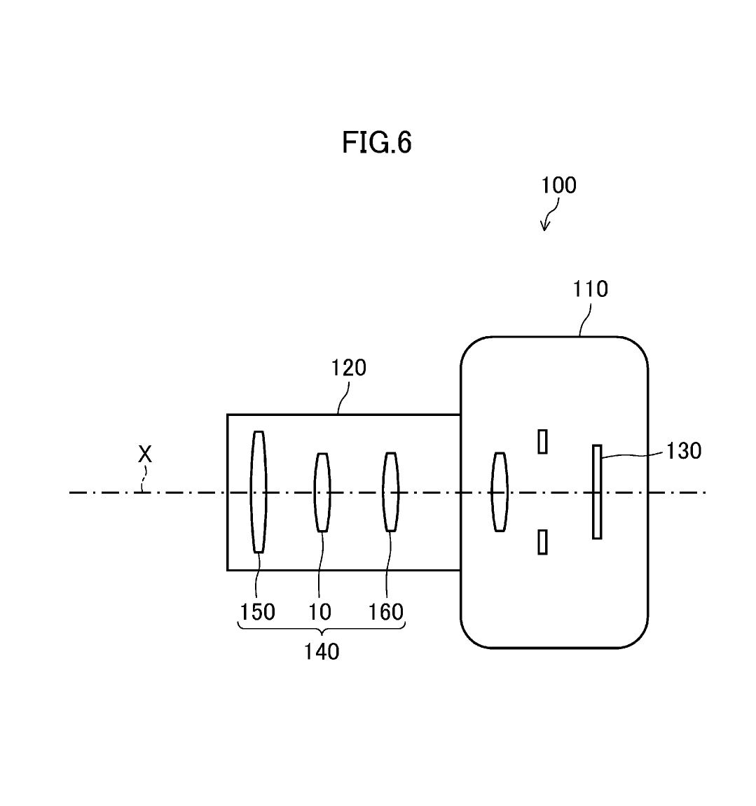

Next, a camera 100 including the lens 10 will be described. FIG. 6 is a schematic view illustrating the camera 100.

The camera 100 includes a camera body 110, and an interchangeable lens 120 attached to the camera body 110. The camera 100 is an example of an imaging apparatus.

The camera body 110 includes an imaging element 130.

The interchangeable lens 120 is configured to be detachable from the camera body 110. The interchangeable lens 120 is, for example, a telephoto zoom lens. The interchangeable lens 120 includes an imaging optical system 140 for focusing a light bundle on the imaging element 130 of the camera body 110. The imaging optical system 140 includes the lens 10 and refracting lenses 150 and 160. The lens 10 serves as a lens element.

[5. Advantages]

Therefore, the lens 10 includes the first optical surface 14, and the first cut end surface 12a outside the first optical surface 14. The first optical surface 14 includes the SWS 13 configured to reduce reflection of light. The first cut end surface 12a includes the SWS 13 configured to reduce reflection of light and the reflection surface 18 configured to reflect predetermined light.

With this configuration, the SWS 13 is formed not only on the first optical surface 14 but also on the first cut end surface 12a, so that reflection of the entire lens 10 can be reduced. Additionally, since the reflection surface 18 is formed on the first cut end surface 12a, the tilt of the lens 10 can be adjusted by using the reflection surface 18. That is, it is possible to achieve both the reduction of the reflection of portions other than optical functional surface and the adjustment of the tile of the lens.

The reflectance of the reflection surface 18 with respect to infrared light is higher than the reflectance of the SWS 13 of the first optical surface 14 with respect to the infrared light.

With this configuration, the reflection surface 18 of the first cut end surface 12a can be irradiated with infrared light to adjust the tilt of the lens 10.

The reflectance of the reflection surface 18 with respect to infrared light is higher than the reflectance of the SWS 13 of the first cut end surface 12a with respect to the infrared light.

The configuration described above includes the SWS 13 provided on the first cut end surface 12a, but the reflection surface 18 is provided, so that the reflection surface 18 of the first cut end surface 12a can be irradiated with infrared light to adjust the tilt of the lens 10.

The SWS 13 is configured to reduce reflection of light having a first wavelength. The reflection surface 18 is configured to reflect light having a second wavelength different from the first wavelength.

With this configuration, the reflection surface 18 can be irradiated with the light having the second wavelength to adjust the tilt of the lens 10. Note that as long as the reflection surface 18 is configured to reflect the light having the second wavelength different from the first wavelength, the reflection surface 18 may reduce reflection of the light having the first wavelength or may reflect the light having the first wavelength.

Specifically, the light having the first wavelength is visible light, and the light having the second wavelength is infrared light.

With this configuration, reflection of visible light at the entire lens 10 can be reduced. When the lens 10 and an apparatus including the same are directed to people, reducing reflection of visible light is very effective. Moreover, when light reflected at the reflection surface 18 is infrared light, people cannot visually identify the light reflected at the reflection surface 18. That is, when the lens 10 and an apparatus including the same are directed to people, it is also effective that the light reflected at the reflection surface 18 is infrared light.

The reflection surface 18 is orthogonal to the optical axis X of the first optical surface 14.

With this configuration, the tilt of the lens 10 is adjusted by using light reflected at the reflection surface 18 orthogonal to the optical axis X, which allows the tilt of the optical axis X to be easily adjusted.

The reflection surface is formed in part of the first cut end surface 12a in the circumferential direction.

With this configuration, the reflection surface 18 is formed only in part of the first cut end surface 12a in the circumferential direction, and the SWS 13 is formed on the first cut end surface 12a other than the part in which the reflection surface 18 is formed. Thus, reflection of light at the first cut end surface 12a can be reduced as much as possible.

The camera 100 includes the lens 10.

With this configuration, reflection at the entire lens 10 of the camera 100 can be reduced, and the optical axis X of the lens 10 can precisely match the optical axis of the lens barrel.

[6. Variation]

Next, lenses according to variations will be described.

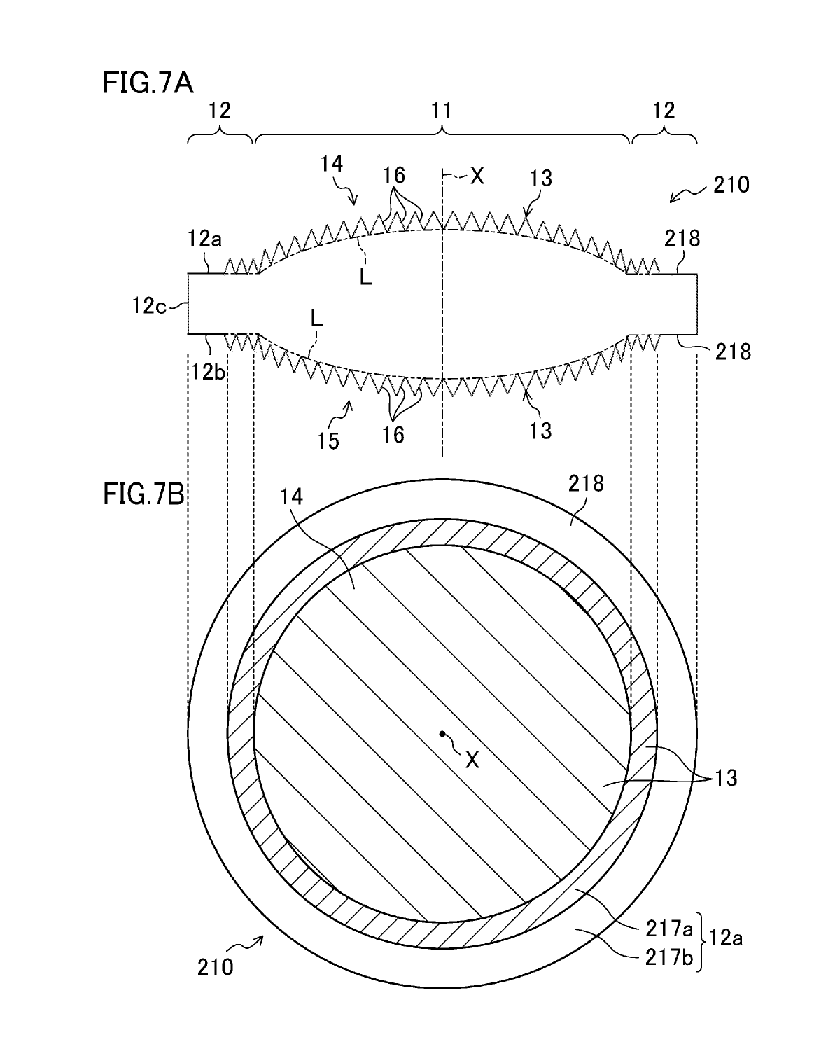

FIGS. 7A and 7B shows a lens 210 according to a first variation, where FIG. 7A is a sectional view, and FIG. 7B is a plan view. Note that in FIG. 7B, raised portions 16 are omitted.

A first cut end surface 12a of the lens 210 is divided into a radially inside region 217a and a radially outside region 217b. A SWS 13 is formed in the radially inside region 217a, and a reflection surface 218 is formed in the radially outside region 217b. Both the SWS 13 and the reflection surface 218 are formed along an entire circumference of the first cut end surface 12. That is, in a radially inside part of the first cut end surface 12a, the SWS 13 is provided along the entire circumference, and in a radially outside part of the first cut end surface 12a, the reflection surface 218 is provided along the entire circumference. The reflection surface 218 is formed to have an annular shape with respect to an optical axis X.

Moreover, on a second cut end surface 12b of the lens 210, a SWS 13 and a reflection surface 218 are also provided in the same manner as the first cut end surface 12a.

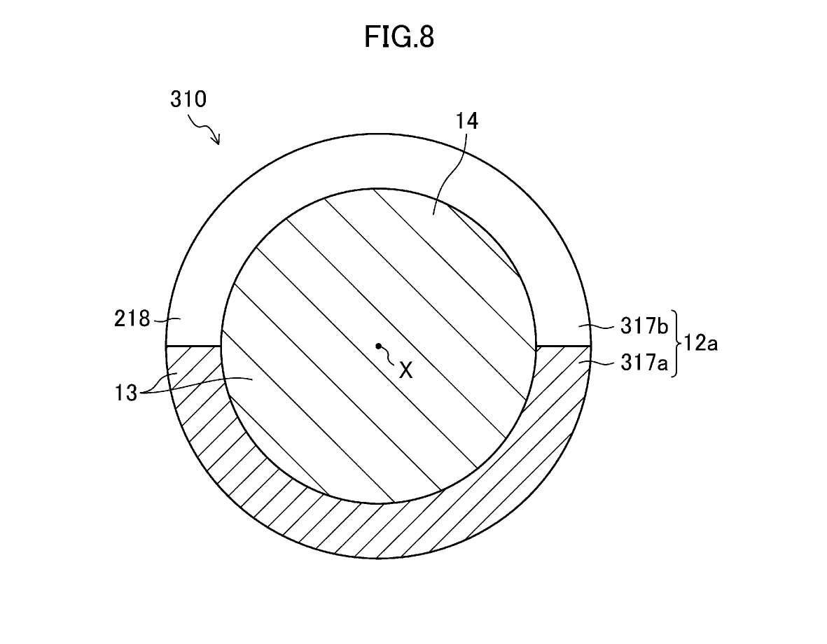

FIG. 8 is a plan view illustrating a lens 310 according to a second variation. Note that in FIG. 8, raised portions 16 are omitted.

A first cut end surface 12a of the lens 310 is divided into two semicircular arc-shaped regions 317a and 317b in a circumference direction. A SWS 13 is formed in the arc-shaped region 317a, and a reflection surface 318 is formed in the arc-shaped region 317b. The reflection surface 318 is formed to have a semicircular arc-shape with respect to an optical axis X.

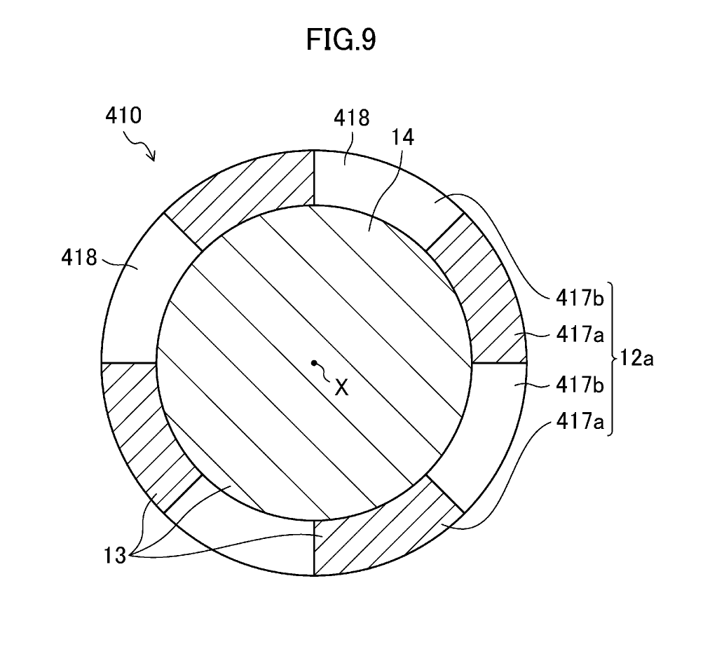

FIG. 9 is a plan view illustrating a lens 410 according to a third variation. Note that in FIG. 9, raised portions 16 are omitted.

A first cut end surface 12a of the lens 410 is divided into eight arc-shaped regions in a circumference direction. Here, arc-shaped regions 417a in each of which a SWS 13 is formed and arc-shaped regions 417b in each of which a reflection surface 418 is formed are alternately disposed. The reflection surfaces 418 are formed to have an arc-shape with respect to an optical axis X.

### Other Embodiments

As described above, the embodiments have been described as example techniques disclosed in the present application. However, the techniques according to the present disclosure are not limited to these embodiments, but are also applicable to those where modifications, substitutions, additions, and omissions are made. In addition, elements described in the embodiments may be combined to provide a different embodiment. As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

Embodiments of the present disclosure may have the following configurations.

It is not necessary that the SWSs 13 are provided on the first optical surface 14 and the second optical surface 15, but the SWS 13 may be provided either one of the surfaces. Alternatively, it is not necessary that the SWSs 13 are provided on the first cut end surface 12a and the second cut end surface 12b, but the SWS 13 may be provided either one of the surfaces. The SWS 13 may be provided on the outer circumferential surface 12c.

The reflection surface 18, 218, 318, 418 is provided on the first cut end surface 12a, but is not limited to this configuration. Alternatively, the reflection surface 18, 218, 318, 418 may be provided on the second cut end surface 12b. Alternatively, the reflection surface 18, 218, 318, 418 may be provided on both the first cut end surface 12a and the second cut end surface 12b.

The antireflection structure is not limited to the SWS. The antireflection structure may be an AR coating or an AR sheet including one or more thin films. The AR coating and the AR sheet can be those reducing reflection by light interference. The AR coating is applied to a surface of the optical portion 11. The AR sheet is attached to the surface of the optical portion 11. A reflection surface configured to reflect light having a predetermined wavelength (e.g., infrared light) is formed in part of the AR coating or the AR sheet which is provided on a portion corresponding to the cut end surface. Alternatively, the antireflection structure may be a structure having fine gaps in a layer provided on an optical surface. Even in such antireflection structures, a reflection surface configured to reflect light having a predetermined wavelength (e.g., infrared light) is formed in part of the antireflection structure on the cut end surface. Also with this configuration, it is possible to reduce reflection not only at the optical functional surface but also at the cut end surface, and additionally, the tilt of the lens can be adjusted.

The reflection surface 18, 218, 318, 418 is, but not limited to be, flat. The reflection surface 18, 218, 318, 418 may have any shape as long as the reflection surface 18, 218, 318, 418 reflects light having a predetermined wavelength (infrared light in the embodiment). For example, the reflection surface 18, 218, 318, 418 may have a reflectance of 1% or higher for light having a predetermined wavelength. Alternatively, the reflectance of the reflection surface 18, 218, 318, 418 with respect to light having a predetermined wavelength may be higher than the reflectance of the optical functional surface (the first optical surface 14 in the embodiment) with respect to the light having the predetermined wavelength. Alternatively, the reflectance of the reflection surface 18, 218, 318, 418 with respect to light having a predetermined wavelength may be higher than the reflectance of the SWS 13 provided on the cut end surface with respect to the light having the predetermined wavelength.

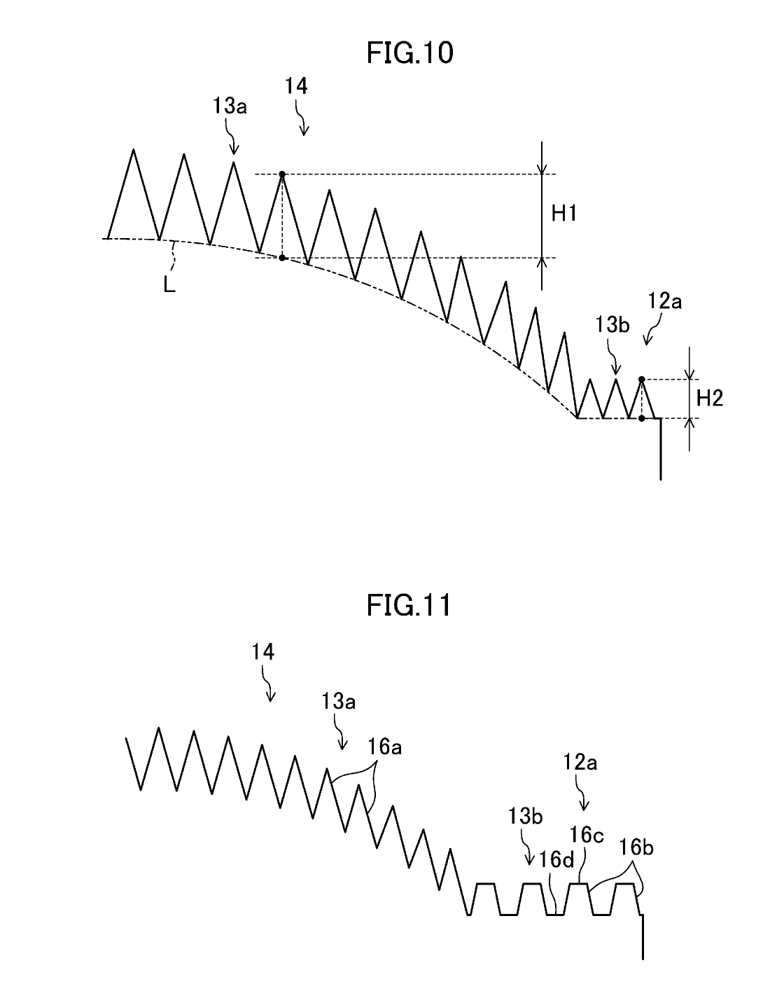

Specifically, as illustrated in FIG. 10, the SWS may be formed on the reflection surface 18, 218, 318, 418. In this case, a first SWS 13a is provided on the first optical surface 14 serving as an optical functional surface, and a second SWS 13b having reflection properties different from those of the first SWS 13a is provided on the first cut end surface 12a. The reflectance of the second SWS 13b with respect to infrared light is higher than the reflectance of the first SWS 13a with respect to the infrared light. For example, the height of each of second raised portions 16b of the second SWS 13b is lower than the height of each of first raised portions 16a of the first SWS 13a.

Alternatively, as illustrated in FIG. 11, in a second SWS 13b, flat surfaces 16c may be formed at top portions of a plurality of second raised portions 16b, and flat surfaces 16d may be formed at bottoms of recessed portions each formed by being surrounded by the second raised portions 16b. Here, the distance between the flat surface 16c of the second raised portion 16b and the flat surface 16d of the recessed portion in the optical axis direction is set to approximately a half of a predetermined wavelength. In this configuration, light having a predetermined wavelength and reflected at the flat surfaces 16d of the recessed portions and light having the predetermined wavelength and reflected at the flat surfaces 16c of the second raised portions 16b interfere with each other, and thus are enhanced. Consequently, the reflectance of light having the predetermined wavelength at the second SWS 13b increases.

That is, the first cut end surface 12a having the configuration of FIGS. 10 and 11 has the second SWS 13b serving as an antireflection structure configured to reduce reflection of visible light and reflecting infrared light, and serving as a reflection surface.

Note that the SWS 13 of the optical functional surface may reduce reflection of light having a predetermined first wavelength, and may, but not necessarily, reduce reflection of light having a second wavelength for which the reflection surface 18, 218, 318, 418 is provided. In the same manner, the reflection surface 18, 218, 318, 418 may reflect light having a predetermined wavelength, and may reflect or reduce reflection of light having a first wavelength (visible light in the embodiment) for which the SWS 13 of the optical functional surface is provided.

The SWS 13 reduces reflection of visible light, but light whose reflection is reduced by the SWS 13 is not necessarily visible light. Light for which the SWS 13 is provided can accordingly be determined depending on use conditions of the lens 10. The pitch, the height, etc. of the raised portions 16 of the SWS 13 can be changed to change the wavelength of light whose reflection is reduced by the SWS 13. Likewise, the reflection surface 18, 218, 318, 418 reflects infrared light, but light reflected at the reflection surface 18, 218, 318, 418 is not necessarily infrared light. Light for which the reflection surface 18, 218, 318, 418 is provided may be light used for adjusting the tilt of the lens 10. Note that when the optical element is directed to use by people, light for which the reflection surface 18, 218, 318, 418 is provided is preferably invisible light such as ultraviolet light, infrared light, etc. That is, when light is reflected at the reflection surface 18, 218, 318, 418, the reflected light is invisible light, so that people cannot visually identify the reflected light.

Moreover, it is not necessary that the configurations of the SWSs 13 of the first optical surface 14 and the second optical surface 15 are the same as those of the SWSs 13 of the first cut end surface 12a and the second cut end surface 12b.

Moreover, the reflection surface 18, 218, 318, 418 reflects infrared light, but the reflection surface 18, 218, 318, 418 does not need to reflect infrared light in the entire infrared range. The reflection surface 18, 218, 318, 418 may reflect light having at least one wavelength in the infrared range. By using the light having the one wavelength, the tilt of the lens 10 can be adjusted. Note that when the reflection surface 18, 218, 318, 418 reflects the infrared light in the entire infrared range, it is possible to extend the selection range of infrared light used for adjusting the tilt of the lens 10.

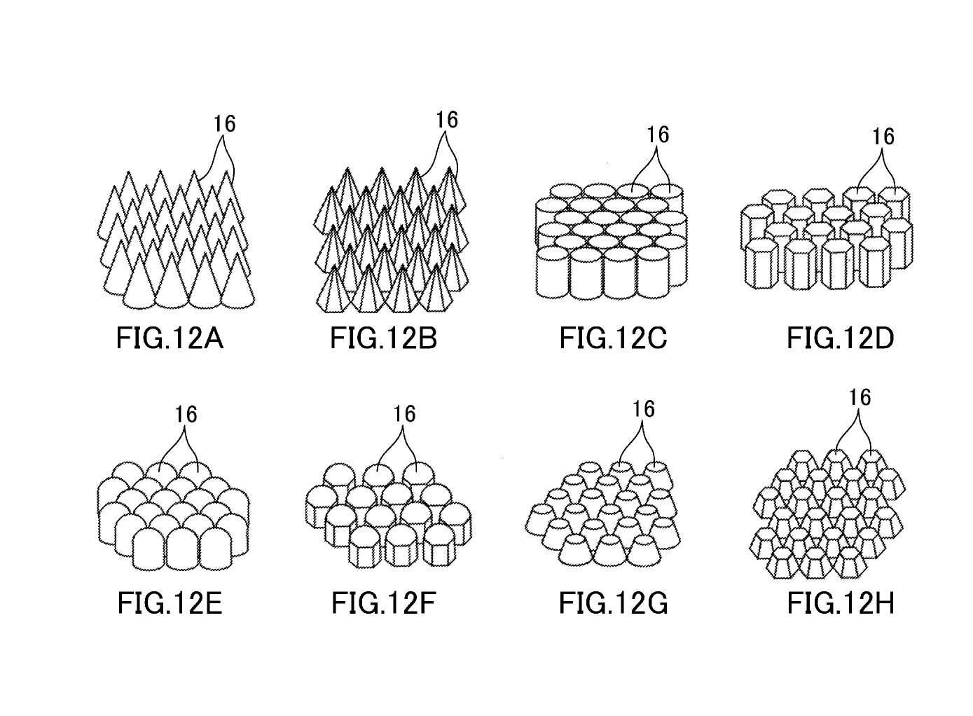

The structural unit of the SWS 13 has a conical shape (see FIG. 12A), but the shape of the structural units is not limited to this shape. Alternatively, as illustrated in FIG. 12B, the structural unit may be in the shape of a pyramid such as a hexagonal pyramid, a quadrangular pyramid, etc. The structural unit may be in the shape of a column as illustrated in FIG. 12C, or a prism as illustrated in FIG. 12D. Alternatively, the structural unit may be in the shape of a column or a prism whose top portion is rounded as illustrated in FIG. 12E or FIG. 12F. The structural unit may be in the shape of a truncated cone or a truncated pyramid as illustrated in FIG. 12G or FIG. 12H.

Moreover, the structural units may be raised portions formed by forming a plurality of recessed portions, the raised portions each formed by being surrounded by the recessed portions. That is, the raised portions have a relative relationship with respect to the recessed portions. In the SWS, the recessed portions are each formed among the plurality of raised portions, whereas the raised portions are each formed among the plurality of recessed portions. That is, it is possible to say that a plurality of raised portions are arranged in the SWS or that a plurality of recessed portions are arranged in the SWS.

It is not necessary that the structural unit has a geometrically exact shape. The structural units may have a raised shape allowing the structural units to be arranged with a pitch smaller than the wavelength of light whose reflection is to be reduced.

The lens 10 has, but not limited to, a biconvex shape. Alternatively, the lens 10 may have a biconcave shape, a convex meniscus shape, or a concave meniscus shape. Alternatively, it is not necessary that the lens 10 serves as a lens element.

The method for forming the molding die is not limited to the above-described forming method. In the above-described forming method, when the resist dot pattern 44 is formed from the resist mask 43, electron beam lithography is used. However, interference exposure (hologram exposure) or lithography such as X-ray lithography may be used. The mask may be formed by nanoimprinting or a particle array.

As described above, the technique disclosed herein is useful for optical elements having antireflection structures configured to reduce reflection of incident light. For example, by using the optical element disclosed herein, it is possible to obtain various optical systems such as high-quality imaging optical systems, objective optical systems, scanning optical systems, and pickup optical systems, various optical units such as barrel units, optical pickup units, and imaging units, imaging apparatuses, optical pickup devices, optical scanning devices, etc.

Various embodiments have been described above as example techniques of the present disclosure, in which the attached drawings and the detailed description are provided.

Since the embodiments described above are intended to illustrate the techniques in the present disclosure, it is intended by the following claims to claim any and all modifications, substitutions, additions, and omissions that fall within the proper scope of the claims appropriately interpreted in accordance with the doctrine of equivalents and other applicable judicial doctrines.

What is claimed is:

1. An optical element comprising:
an optical functional surface; and
a peripheral surface outside the optical functional surface, wherein
the optical functional surface has an antireflection structure configured to reduce reflection of light, and
the peripheral surface has an antireflection structure configured to reduce reflection of light and a reflection surface configured to reflect light having a predetermined wavelength.

2. The optical element of claim 1, wherein
a reflectance of the reflection surface with respect to the light having the predetermined wavelength is higher than a reflectance of the antireflection structure of the optical functional surface with respect to the light having the predetermined wavelength.

3. The optical element of claim 1, wherein
a reflectance of the reflection surface with respect to the light having the predetermined wavelength is higher than a reflectance of the antireflection structure of the peripheral surface with respect to the light having the predetermined wavelength.

4. The optical element of claim 1, wherein
the antireflection structure is configured to reduce reflection of light having a predetermined first wavelength, and
the reflection surface is configured to reflect light having a second wavelength different from the first wavelength.

5. The optical element of claim 4, wherein
the light having the first wavelength is visible light, and
the light having the second wavelength is infrared light.

6. The optical element of claim 1, wherein
the reflection surface is orthogonal to an optical axis of the optical functional surface.

7. The optical element of claim 1, wherein
the reflection surface is formed in part of the peripheral surface in a circumference direction.

8. The optical element of claim 1, wherein
the reflection surface is formed along an entire circumference of the peripheral surface.

9. An imaging apparatus comprising:
the optical element of claim 1.
